(19) United States
(12) Patent Application Publication
(10) Pub. No.: US 2010/0171411 A1
(43) Pub. Date: Jul. 8, 2010

(54) CATHODE HEATER

(75) Inventors: Alexander J. Mathers, Everett, WA (US); Valerie McHenry, Maple Valley, WA (US); Nicole Meckel, Kirkland, WA (US); Thomas R. Sanderson, Sammamish, WA (US); Arnold W. Voigt, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: AEROJET-GENERAL CORPORATION, Redmond, WA (US)

(21) Appl. No.: 12/664,034

(22) PCT Filed: Jun. 13, 2008
(86) PCT No.: PCT/US08/66995

§ 371 Date: Jan. 19, 2010

Related U.S. Application Data
(60) Provisional application No. 60/943,815, filed on Jun. 13, 2007.
(60) Provisional application No. 60/969,551, filed on Aug. 31, 2007.

(51) Int. Cl. H01J 1/22; H05B 3/00

(52) U.S. Cl. 313/340; 29/611

(57) ABSTRACT

An assembly of a Ta inner conductor (20) and a Ta outer sheath (22 or 22′) has an intermediate layer (24) of fused grain alumina or aluminum nitride insulation material. The assembly is swaged and wound to form a helical coil of several wraps. Individual wraps can be of square or rectangular cross-section.

### CROSS-REFERENCE TO RELATED APPLICATIONS

This application claims the benefit of U.S. Provisional Application No. 60/943,815, filed Jun. 13, 2007, titled Cathode Heater, and U.S. Provisional Application No. 60/969,551, filed Aug. 31, 2007, titled Increased Power Cathode Heater.

### BACKGROUND

Hall current thrusters commonly use a hollow cathode as the electron source. Before igniting the hollow cathode, it is heated using an external coiled heater element.

Prior art cathode heaters are described in the following articles and the references cited therein:

(1) Soulas, G. C., “Status of Hollow Cathode Heater Development for the Space Station Plasma Contactor,” 30th AIAA/ASME/SAE/ASEE Joint Propulsion Conference, AIAA paper No. 94-3309, June 1994;

(2) Tighe, W. G., et al., “Performance Evaluation and Life Test of the XIPS Hollow Cathode Heater,” 41st AIAA/ASME/SAE/ASEE Joint Propulsion Conference & Exhibit, Tucson, Ariz., Jul. 10-13, 2005; and

(3) Beal, B., et al., “Development of a High-Current Hollow Cathode for High-Power Hall Thrusters, JANNAF Conference, December 2005.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a novel cathode heater that can be scaled to a larger size for greater power output while withstanding the resultant increased temperature to which components of the heater are exposed.

One aspect of the invention pertains to innovative heater materials, particularly insulation materials disposed between inner and outer conductors of a heater.

Another aspect of the invention pertains to a novel cross-section geometry of the individual heater coils.

Aspects of the invention can be used in combination, i.e., innovative insulation materials and processing in combination with novel cross-section geometry to achieve desired performance, such as time at temperature necessary to repeatedly start and/or reactivate thermionic emission of the cathode.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 (Prior Art) is a schematic representation of an electron-emitting cathode assembly of a general type in which the present invention may be used;

FIG. 2 is an enlarged schematic perspective representation of a heater in accordance with the present invention, separated from other components of the cathode assembly;

FIG. 3 is a further enlarged schematic perspective of the distal tip portion of the heater of FIG. 2, with parts broken away;

FIG. 4 is a schematic perspective representation of a second embodiment of a heater in accordance with the present invention, separated from other components of a cathode assembly, and

FIG. 5 is a similar schematic perspective viewed from the opposite, distal end of the heater; and

FIG. 6 is an enlarged, fragmentary, detail view of a coiled portion of the heater of FIGS. 4 and 5, with parts broken away and parts shown in section.

### DETAILED DESCRIPTION

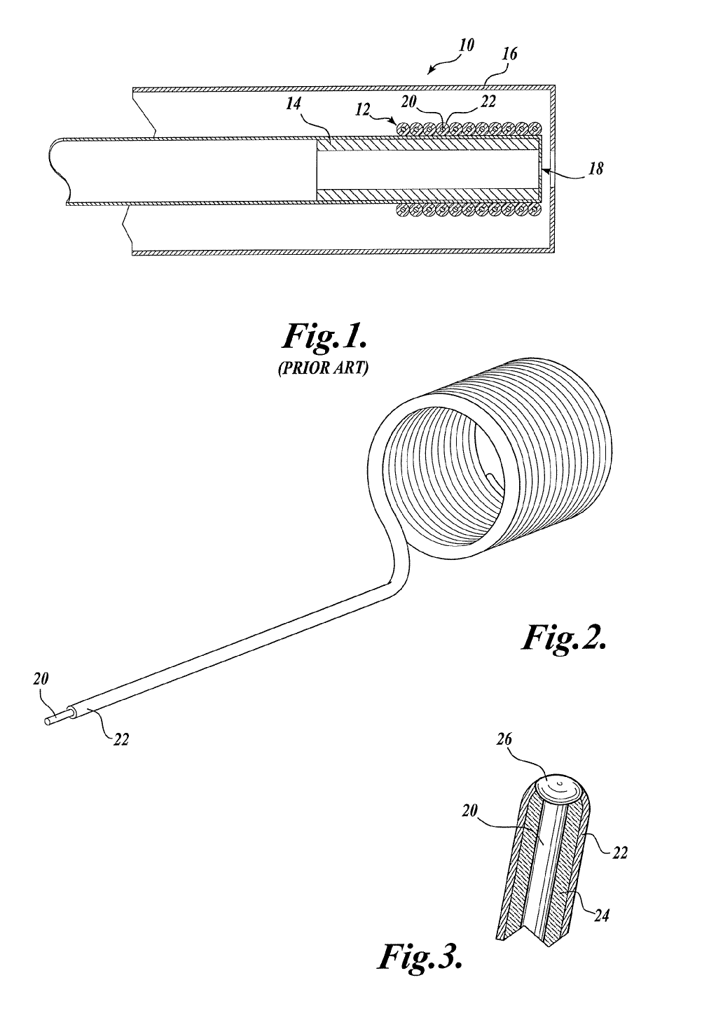

FIG. 1 is a schematic representation of an electron-emitting cathode assembly 10 of a general type in which the present invention may be used. The invention pertains to the manufacture and construction of the heater 12 surrounding the hollow, electron-emitting cathode core or insert 14. The heater 12 and core or insert 14 fit inside the outer keeper electrode 16. The insert and keeper have an orifice region 18 through which electrons are emitted. In general, the heater raises the temperature of the cathode sufficiently to provide adequate electron emission for ignition. The cathode insert then becomes self-heated by the plasma interaction, and the heater is deactivated. The cathode may be part of an ion thruster for a spacecraft, used for station-keeping and on-orbit repositioning. For such missions, the thruster cathode may be operated for several thousand on-off cycles in a desired lifetime. The heater represents a potential single-point failure in the thruster, so that reliability is essential.

In a representative prior art cathode heater, an inner tantalum (Ta) conductor 20 extends through an outer Ta conductor 22. An annular layer of magnesium oxide (MgO) insulation is provided between the two conductors. The conductors are electrically connected at the coiled tip, such as by a tungsten inert gas (TIG) weld, to complete the electrical circuit. The heater is manufactured by sliding MgO beads over the center conductor and into the outer conducting sheath or tube. This assembly is then swaged, reducing the outer tube diameter and crushing the MgO beads. A second swage reduces both the inner and outer conductor diameter and is performed on a section that is long enough to be coiled into the helical portion or “hot section” of the heater. Then, as mentioned above, the inner conductor is coupled to the outer conductor at the tip so that current can flow in through the center conductor and return along the outer conductor. In a typical application, the heater is operated at constant current. At turn on, the initial low resistance of the inner conductor wire rises as the temperature increases. With constant current, the heater voltage rises with the resistance.

Such heaters have been qualified for space flight on ¼ inch hollow cathodes, and have demonstrated life times in excess of 6 thousand cycles. During testing, the primary cause of failure, assuming minimal manufacturing defects, no material purity problems, no test environment problems, and so on, is time at temperature. Heaters at higher temperatures fail in a shorter period of time than those at lower temperature. The prior art MgO insulator heaters with Ta conductors exhibit problems at temperatures above 1100° C. At the higher temperatures, Ta and conducting tantalades defuse through the MgO providing conducting paths. Leakage current across the MgO insulator exacerbates the failure by heating the MgO, leading to structural changes to the heater materials. Breaches in the outer conductor lead to loss of the insulation. Additional and more rapid heating of the center conductor can result. Rise in temperature and loss of structural support of the center conductor result in movement of the inner conductor toward the outer conductor. The reduced separation facilitates shorts. The inner conductor can reach temperatures that lead to fracture and in open circuit conditions. The ultimate result is catastrophic failure of the heater.

To date, heaters of the type described above have been used for cathodes with diameters of ¼ inch and ½ inch. A ¼ inch cathode may require a heater that delivers 65 W. A ½ inch heater may require a cathode that delivers 100 W. Development work is being conducted on larger cathodes, such as a ¾ inch cathode that could require 150-200 W. At the higher power levels, thermal models predict the center conductor of the heater can approach temperatures as high as 2000° C. At such temperatures, the heater materials (both conductors and insulators) can degrade quickly to the point of failure.

With reference to FIGS. 2 and 3, in one aspect of the present invention the manufacturing process and materials are modified to withstand higher temperatures, allowing larger more robust heaters, and potentially increasing reliability and lifetime of even smaller heaters. In a representative embodiment, the inner conductor 20 is a wire of annealed Ta of at least 99.95% purity and of circular cross-section. In one aspect of the invention, it was discovered that the insulation material 24 can be fused grain alumina, rather than MgO. The grains of alumina are electrically fused, such as at 1560° C., prior to forming, which reduces shrinkage at high temperature. In terms of sintering and shrinkage, the fused grain alumina material responds similarly to MgO. However, it has been found that structural integrity and maintenance of insulative properties at higher temperatures is enhanced. In one preferred embodiment, structural integrity and insulative properties will be maintained at temperatures of 2000° C. over thousands of cycles, which allows larger, higher power heaters.

In the present invention, during assembly, long cylindrical insulator beads are threaded onto the Ta wire 20, then the Ta sheath 22 is slipped over the bead-wire assembly. The entire assembly is pressed to a smaller diameter by rotary swaging. The “hot zone” end 26 of the heater is welded so that the outer sheath provides the current return path for current applied to the center conductor. The welded or distal end portion of the swaged cable is coiled around a mandrel having approximately the diameter of the cathode tube or insert.

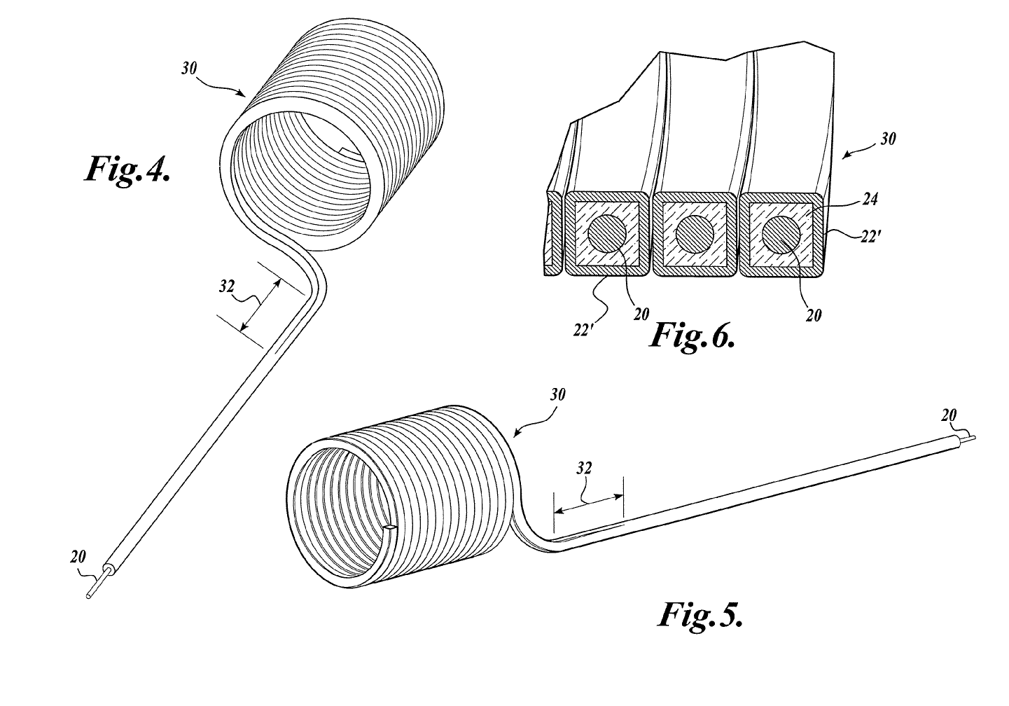

With reference to FIG. 4, in another aspect of the present invention, the wire-insulation-sheath assembly 30 is subjected to another rotary swaging step to transform it to a rectangular or, preferably, square cross-section before coiling. In addition to reducing the thermal resistance, this improves the packing density of the coil and improves temperature uniformity in the “hot zone” of the heater. A greater and more uniform generally helical surface of the heater coil is adjacent to the cathode insert. Power required to heat the cathode may be reduced, and the center conductor operating temperature may be reduced.

More specifically, in one embodiment pure calcide alumina is fused at about 2000° C. The resulting fused grain alumina is wet extruded with binder to the desired bead shape (at least two to three inch long cylinders having an axial bore of a diameter approximately equal to the diameter of the inner conductor 20 and an outer diameter approximately equal to the inner diameter of the sheath conductor 22′). The beads are processed at 1560° C. Prior to swaging, the outer diameter of the sheath 22′ is 0.084 to 0.086 inch, the Ta inner conductor is approximately 0.028 to 0.030 inch in diameter, the Ta outer sheath has a wall thickness of 0.0063 to 0.0077 inch, and the insulator beads are sized for a reasonably snug fit on the inner Ta conductor and inside the outer Ta conductor. After swaging, the dimensions are: inner conductor OD 0.024 to 0.026 inch; and outer conductor width 0.058 to 0.062 inch measured from the outside of opposite flat walls. The outside corners are slightly rounded. The compaction density is greater than 70%, preferably greater than 80% and sometimes higher. The compaction density is believed to assist in minimizing voids that may lead to failure. The hot zone is wound on a mandrel for 16 full coils of an inner diameter of 0.730 to 0.740 inch and the individual coils are preferably spaced apart in an axial direction by 0.002 to 0.010 inch. The cross-section can transition from square in the coiled area to a circular cross-section at a location 32 proximal from the coiled hot zone.

After the coiling is done, in another aspect of the invention, the heater is annealed. Annealing can be at a vacuum level of less than 1×10⁻⁴ Torr. More specifically, the annealing process can be as follows:
1. heat to 260±14° C. (500±25° F.) and hold for 20 to 30 minutes;
2. heat to 1093±14° C. (2000±25° F.) at a rate of 17 to 22° C. (30 to 40° F.) per minute;
3. hold at 1093±14° C. (2000±25° F.) for 10 to 20 minutes minimum;
4. heat to 1357±14° C. (2475±25° F.) at a rate of 17 to 22° C. (30 to 40° F.) per minute;
5. hold at 1357±14° C. (2475±25° F.) for 120±10 minutes; and
6. vacuum cool to 982° C. (1800° F.) followed by dry argon backfill cooling to approximately 121° C. (250° F.).

Testing of a heater of the design described above has shown the potential to sustain the high power operation necessary for a ¾ inch hollow cathode. Research and testing are ongoing.

In another embodiment of the invention, an insulator 24 is selected which will exhibit high thermal conductivity, preferably at least one order of magnitude higher than the thermal conductivity of MgO. It was discovered that one such material is aluminum nitride (AlN), such as the “ST-100” (essentially pure aluminum nitride) or “ST-200” (aluminum nitride with a small amount of yttrium oxide, Y₂O₃) available from Sienna Technologies Inc. of Woodinville, Wash. For example, with the yttrium oxide the aluminum nitride insulator material may sinter at 1700° C., whereas without the yttrium oxide it may sinter at 2000° C., but the thermal conductivity is greater with the yttrium oxide. For an embodiment of AN with yttrium oxide, the additive is preferably in the range of 0.5% to 4%. Magnesium oxide (MgO) has a thermal conductivity of 42 W/mK at room temperature and the thermal conductivity will decrease at higher temperatures. At 1500° C., other materials previously proposed for the insulator can have thermal conductivity approaching 5 W/mK. Even at the higher temperatures, aluminum nitride retains high thermal conductivity relative to other materials, will not react with tantalum, and electrical insulation is maintained despite the high heat transfer. The heat transfer allows the center conductor to operate at lower temperatures for a given power. Using the higher heat conductivity of the aluminum nitride insulation can result in the power required to heat the cathode being reduced by 10-15% or more, and the center conductor operating temperature may be reduced by about 300° C., particularly when the high heat conductivity insulation is used in a heater for which the coils have the square or rectangular cross-section in the hot zone. Both aspects assist in maintaining a smaller heat gradient across the insulation while transferring heat effectively.

In other respects, the embodiment using AlN insulation is identical to the embodiment using fused grain alumina, including the annealing process.

While illustrative embodiments have been illustrated and described, it will be appreciated that various changes can be made therein without departing from the spirit and scope of the invention.

The embodiments of the invention in which an exclusive property or privilege is claimed are defined as follows:

1. A cathode heater comprising:
an inner electrical conductor wire (20);
an outer electrical conductor sheath (22 or 22′) encircling the inner conductor wire, the wire (20) and sheath (22 or 22′) having corresponding ends electrically coupled; and
a layer of insulation material (24) between the wire (20) and sheath (22 or 22′), the insulation material being fused grain alumina, the wire, sheath and insulation being wound to a helical coil of several wraps.

2. The heater of claim 1, in which individual wraps are of rectangular or square cross-section.

3. A cathode heater comprising:
an inner electrical conductor wire (20);
an outer electrical conductor sheath (22 or 22′) encircling the inner conductor wire, the wire (20) and sheath (22 or 22′) having corresponding ends electrically coupled; and
a layer of insulation material (24) between the wire (20) and sheath (22 or 22′), the insulation material being aluminum nitride, the wire, sheath and insulation being wound to a helical coil of several wraps.

4. The heater of claim 3, in which individual wraps are of rectangular or square cross-section.

5. The heater of claim 3, in which the insulation material contains 0.5% to 4% yttrium oxide.

6. A cathode heater comprising:
an inner electrical conductor wire (2);
an outer electrical conductor sheath (22′) encircling the inner conductor wire, the wire (20) and sheath (22′) having corresponding ends electrically coupled; and
a layer of insulation material (24) between the wire (20) and sheath (22′) the wire, sheath and insulation being wound to a helical coil of several wraps, and individual wraps being of rectangular or square cross-section.

7. The method of making a cathode heater which comprises:
forming an assembly of an inner Ta wire (20), an outer Ta sheath (22′) encircling the wire and a layer of fused grain alumina or aluminum nitride insulation material between the wire and sheath;
swaging the assembly to a square or rectangular cross-section;
winding the swaged assembly to a helical coil of several wraps; and
annealing the helical coil.
